(19) United States
(12) Patent Application Publication
(10) Pub. No.: US 2026/0368604 A1
(43) Pub. Date: Nov. 19, 2026

(54) MULTIDIMENSIONAL QUANTUM REPLICAS

(71) Applicant: Bank of America Corporation, Charlotte, NC (US)

(72) Inventors: Manu Kurian, Dallas, TX (US); Ashley Laine Ghosh, McKinney, TX (US)

(21) Appl. No.: 18/746,112

(22) Filed: Jun. 18, 2024

(51) Int. Cl. G06N 10/70; G06N 10/20; H04L 9/08

(52) U.S. Cl. CPC G06N 10/70; G06N 10/20; H04L 9/0852

(57) ABSTRACT

The system may include an apparatus for reduction of risk from an unauthorized party accessing a quantum computer, where reduction of risk may be achieved in real-time using a quantum digital twin. The system may include the quantum computer configured to establish the quantum digital twin between a sets of qubits on quantum computers by using quantum entanglement, encrypt stored data using quantum cryptography to make encrypted data that is stored on the set of qubits, transport through quantum entanglement the encrypted data from one set of qubits to another, monitor and detect a party that obtains unauthorized access to the encrypted data, cleanse in real-time the encrypted data to prevent further access to the unauthorized party, and restore encrypted data to the set of qubits that were cleansed by transporting, using quantum entanglement, the encrypted data that was stored another set of qubits on another quantum computer.

### FIELD OF TECHNOLOGY

Aspects of the disclosure relate to risk management using a quantum digital twin.

### BACKGROUND

Computational devices, such as computers, phones, tablets, Internet of things (“IoT”) devices, and the like may be subject to compromise of their data and functionality. A compromise in data and devices may come from a malicious party. The malicious party may breach a network or device and take advantage of the access for illegal gain.

Owners and administrators of computational devices may seek to protect themselves from compromise of their data and devices. If a malicious party compromises the computational device, the owners and administrators may seek ways to recover the functionality and memory of the compromised computational device. One such example may include creating backups of the computational device when possible.

There may be a lag in implementation of solutions to the compromise due to delay in processing time. The lag time may give the malicious compromising party time to cause further damage to a compromised computational device and network as well as other computational devices and networks in electronic communication with these.

There may be a need to protect computational devices from attack by a malicious compromising party.

There may be a further need to minimize damage done to the computational devices and data stored on them once there has been a compromise.

There may be another need to act in real-time to outpace the malicious compromising party to stop damage to other computational devices that are in electronic communication with the compromised device.

There may be a further need to facilitate recovery of the compromised computational device.

### SUMMARY

It may be an object of the invention to protect computational devices from compromise by a malicious party. A device may include a computational device. An unauthorized user may include a malicious party.

It may be a further object of the invention to minimize damage done to the devices once there has been a compromise.

It may be an additional object of the invention to act in real-time. Acting in real-time may outpace the unauthorized party and stop the unauthorized party from breaching other devices that are in electronic communication with the device.

It may be a further object of the invention to facilitate recovery of the compromised device and data.

Included may be a method for reducing risk from an unauthorized party accessing a device. Further included may be reducing risk in real-time using a quantum digital twin.

The method may include using a first quantum computer to establish the quantum digital twin between a first set of qubits on a first quantum computer and a second set of qubits on a second quantum computer by using quantum entanglement. The quantum entanglement of the first set of qubits and the second set of qubits may be maintained by applying quantum error correction (“QEC”) to maintain coherence of the first set of qubits and the second set of qubits.

The first quantum computer may encrypt data stored on the first quantum computer using quantum cryptography to make encrypted data. The encrypted data may be stored on the first set of qubits.

The first quantum computer may transport through quantum entanglement the encrypted data stored on the first set of qubits on the first quantum computer to a second set of qubits on the second quantum computer.

The second quantum computer may monitor for a party that obtains unauthorized access to the encrypted data on the first set of qubits on the first quantum computer.

The second quantum computer may detect a party obtaining unauthorized access to the encrypted data on the first set of qubits on the first quantum computer.

The second quantum computer may cleanse in real-time the second quantum computer, the encrypted data of the first set of qubits on the first quantum computer.

The second quantum computer may restore encrypted data to the first set of qubits on the first quantum computer by transporting, using quantum entanglement, encrypted data stored on the second set of qubits on the second quantum computer to the first set of qubits on the first quantum computer.

Real-time cleansing using quantum computing may cause the encrypted data to be removed from the memory of the first set of qubits on the first quantum computer before the second quantum computer is subject to unauthorized access.

The encrypted data on the first set of qubits may be cleansed by disrupting coherence between the first set of qubits and the second set of qubits causing the first set of qubits to lose their quantum state.

The first quantum computer may be directly connected to a quantum internet.

The second quantum computer may only have a connection to a quantum internet through electronic connection to the first quantum computer.

The first quantum computer may apply QEC to maintain quantum states of the first set of qubits and the second set of qubits. Applying QEC may establish coherence between the first set of qubits and the second set of qubits.

The encrypted data on the first set of qubits may be cleansed by applying QEC to disrupt coherence between the first set of qubits and the second set of qubits causing the first set of qubits to lose their quantum state.

The first quantum computer may tag quantum states of the first set of qubits with a first tag and the second set of qubits with a second tag. The first tag may be used to identify the first location of the first set of qubits. The second tag may be used to identify a second location of the second set of qubits.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram in accordance with principles of the disclosure;

FIG. 2 shows an illustrative flowchart in accordance with principles of the disclosure;

FIG. 3 shows an illustrative flowchart in accordance with principles of the disclosure;

FIG. 4 shows an illustrative block diagram in accordance with principles of the disclosure; and

FIG. 5 shows an illustrative block diagram in accordance with principles of the disclosure.

### DETAILED DESCRIPTION

The apparatus and method may reduce risk from an unauthorized party accessing a device. Further included may be reducing risk in real-time using a quantum digital twin.

Risks associated with an unauthorized party accessing a device may include, for example, loss of the memory stored on the device, access by the intruding party to the device's processor, and access to other devices and networks that are connected to the device. Another example of risk may include the unauthorized party ransoming access to the device. Speed of response by the affected party may be important in minimizing the extent of the damage caused by unauthorized access.

A quantum digital twin may include a digital twin that leverages the power of quantum computing to simulate complex systems. A quantum digital twin may offer advantages such as faster simulation, higher accuracy, and greater scalability than a classical digital twin.

A quantum digital twin may create a replicate of data stored on a device. A quantum digital twin may store the replicated data on another device. The other device may be a virtual device. The other device may serve as a backup of the device in case of compromise to the device. The compromise to the device may come, for example, from an authorized party.

A quantum digital twin may be a classic digital twin that uses the power of quantum computing to achieve speed, accuracy, and scalability. A quantum digital twin may use a wave function to establish a digital twin.

The wave function may be a memory that the qubits carry relating to the relationship of the entangled state. The wave function, for every quantum state, may be independent. When a quantum digital twin is created, the wave functions, for every quantum state, may become entangled with one another. Through these wave functions, the quantum twins may interact with each other. A quantum twin may be a virtual twin of the actual qubit that exists in multiple states.

The method may include using a first quantum computer to establish the quantum digital twin between a first set of qubits on a first quantum computer and a second set of qubits on a second quantum computer by using quantum entanglement.

Quantum entanglement may include pushing qubits into the same quantum state. This may include pushing the qubits to be correlated to each other, even if the qubits are not in “contact” with each other. Entangled qubits may interact with other qubits which may allow for many different calculations to be done simultaneously. This may be an advantage of quantum computers that may allow them to work faster than binary computers.

Quantum entanglement may include quantum correlation. Quantum correlation may be a correlation between parts of a quantum system including two or more quantum states. Quantum correlation may be a correlation between parts of a quantum system including two or more qubits.

Quantum entanglement may exist between two or more particles such as qubits. A pair of entangled particles may possess a total spin of zero. For example, if one particle has a spin of “up” then the other entangled particle may have a spin of “down.”

Quantum entanglement may give rise to a paradox. The paradox may include that the wave function of the qubit may collapse when the properties of the qubit are measured.

Entanglement may produce correlation between the measurements. The mutual information that may emerge from correlation of entangled particles may be utilized. One such utilization of quantum entanglement may include the creation of quantum computers which include entangled particles.

Quantum entanglement may be established in different ways. Some examples of establishing quantum entanglement may include entangling the particles from the time they are created. For example, photons may be entangled using a cascade transition. Cascade transition may include putting calcium atoms into a highly excited energy level where their electrons decay by emitting two photons, passing through an intermediate state with a short lifetime.

Another way to establish quantum entanglement may include taking entangled photons and directing them to a pair of atoms that may absorb the entangled photons. The atoms may then possess a similar correlation as the photons. The atoms may be easier to maintain for a longer time than the photons. A longer time may mean a greater amount of time.

A further way to establish quantum entanglement may include taking atoms at various locations that emit photons. The photons may be brought together in a way that leads to entanglement of the photons. This may then lead to entanglement of the original atoms.

Another way to establish quantum entanglement may include a Rydberg blockade scheme. This scheme may include exciting one of two atoms that are relatively close in proximity. When that atom is excited and proceeds to a Rydberg state, that atom may excite the second atom. If successful, the two atoms may be anti-correlated with each other, and thereby entangled.

Quantum systems may change their state when the system is observed or measured. As a result, the original state of the quantum system may not be copied directly since copying may require measuring the state of the quantum system being copied. Not being able to copy a quantum system directly may include not being able to clone to quantum system.

In place of cloning data stored in a quantum system, other methods may be utilized to transfer data in a quantum network. A quantum network may use qubits to transfer and share data between quantum computers. Quantum computers may include quantum processors. Quantum computers may utilize quantum entanglement. Through entanglement, adding extra qubits to a quantum computer may increase the latter's computational power exponentially. Quantum entanglement may be used to store the data set on the second set of qubits concurrently with storage of the data set on the first set of qubits. A direct connection between qubits may be established by sending an entangled photon beam in free space to connect endpoints in a quantum system without the need for a physical medium.

The first quantum computer may encrypt data stored on the first quantum computer using quantum cryptography to make encrypted data, said encrypted data is stored on the first set of qubits. Encrypting data may include concealing information by altering it so that it appears to be random data. Encryption may provide security from compromise by a malicious party. Encrypting the data may include using quantum encryption.

Risks associated with an unauthorized party accessing a device may include a compromise by a malicious party. Compromise by the malicious party may include, for example, loss of the memory stored on the device, access by the intruding party to the device's processor, and access to other devices and networks that are connected to the device. Another example of risk may include the unauthorized party ransoming access to the device. Speed of response by the affected party may be important in minimizing the extent of the damage caused by unauthorized access.

Encryption may include scrambling data so that only authorized parties may understand the information. The process of encrypting may convert human-readable plaintext to incomprehensible text. The incomprehensive text may include ciphertext. Encryption may take readable data and alter it so that it appears random.

Encryption may require use of a cryptographic key. A cryptographic key may include a set of mathematical values that both the sender and the recipient of an encrypted message agree on. The cryptographic key may include a string of characters used within an encryption algorithm for altering data so that it appears random.

The encryption of the data stored on the first device may include symmetric encryption and/or asymmetric encryption. Symmetric encryption may use a private key for encryption and decryption. Asymmetric encryption may utilize both a private key and public key.

Encryption may ensure data integrity and security in multiple ways. For example, encryption may ensure that the rightful owner and intended recipient may access the data. Even if a malicious party should gain access to the data, encryption may ensure that such a party may not make sense of the data and it may just appear as random numbers and letters. Encryption may also ensure that the encrypted data has not been viewed or tampered with as it travels in a network. The malicious party may still hold the encrypted data for ransom even if the malicious party is not able to read the data.

Quantum cryptography may provide for the encrypted data to cease existing. The encrypted data may be stored as qubits. The qubits may be entangled to form a quantum digital twin. The entangled qubits may have coherence with one another. The entangled qubits may be correlated with one another. The data stored on the entangled qubits may cease existing when the state of coherence between the qubits is lost. When coherence between the qubits is lost, the encrypted qubits access by the malicious party may be lost. In such a case, the malicious party may not be able read the data due to quantum encryption. The malicious party may lose the encrypted data once coherence is lost between the qubits.

Quantum cryptography may refer to cybersecurity methods for encrypting and transmitting secure data based on the laws of quantum mechanics. Traditional cryptography may be based on mathematics. Quantum cryptography may be based on physics, for example, unique aspects of quantum mechanics. Some examples of principles of quantum mechanics that may be used in cryptography include the inherent uncertainty of a particle's quantum state on a quantum level, photons may serve as a binary counterpart to zeros and ones based on their polarity and/or spin, the act of measuring a quantum system may affect and alter the system, and/or particles may only be partially cloned or copied but not fully cloned or copied.

Types of quantum cryptography that may be used to encrypt the data stored on the first device may include quantum key distribution (QKD), quantum coin-flipping, position-based quantum cryptography, device-independent quantum cryptography, key-encryption-key (KEK) protocol, and Y-00 protocol.

QKD may include a way to securely distribute keys between parties. The keys may be used in symmetric encryption may use a private key for encryption and decryption.

Quantum coin flipping may use the principles of quantum mechanics to encrypt messages for secure communication, for example, complex and useful cryptographic protocols that include Quantum Byzantine agreement.

Position-based quantum cryptography may use the geographical position of a party as its primary credential.

Device-independent quantum cryptography may not rely on trusting that the quantum devices used are truthful. An example may include measurement-device independent quantum key distribution.

KEK protocol key-encryption may include a key that encrypts another key for transmission or storage.

Y-00 protocol may transmit a message without an eavesdropper being able to monitor the communication.

The quantum computer may encrypt the data stored on the first device with post-quantum cryptography (“PQC”). PQC may be used to secure data and/or devices against both quantum computers and binary computers. PQC may use diverse types of cryptography to create quantum-proof security.

Examples of PQC include Multivariate cryptography, Code-based cryptography, Isogeny-based cryptography, Lattice-based cryptography, Symmetric key quantum resistance, and Hash-based cryptography.

The data may be stored on a first set of qubits. Storing the data on qubits may include storing the data in a quantum memory. Quantum memory may be stored on a quantum memory device. A quantum memory device may store the data as the quantum states of photons. A quantum memory device may store the data as qubits, such as a set of qubits. Qubits may include the quantum state of photons. The data may later be retrieved in the same quantum states.

The first quantum computer may transport the encrypted data stored on the first set of qubits on the first quantum computer to a second set of qubits on the second quantum computer.

Quantum computers may communicate using photons to transport qubits between remote places. An advantage of photons may include that they are well isolated from perturbations. Isolation from perturbations may translate into long-lived superposition states for qubits that are photons. Another advantage of photons is that they may propagate along an optical fiber with low attenuation.

A quantum network may have end nodes on which applications are run. End nodes may include quantum computers that may include quantum processors containing one or more qubits. Quantum computers in the quantum network may communicate over communication lines. These may include fibers optics that may carry. The first device may be a first node. The second device may be a second node.

To transport qubits from one node to another, the quantum network may use communication lines. Communication lines may include telecom fibers such as fiber optics cables. Electromagnetic waves may also be used to transport qubits. Quantum computers may establish quantum entanglement allowing data to be teleported between the quantum computers in the quantum network.

Optical switches may be capable of delivering qubits to the intended quantum processor. The optical switches may be needed to preserve quantum coherence. Quantum coherence may be used to establish quantum entanglement. Quantum entanglement may be used to transport data from the first set of qubits on the first device to the second set of qubits on the second device.

Quantum repeaters may be utilized to transport qubits over long distances. Repeaters may appear between end nodes. Quantum entanglement may establish coherence between qubits at the end nodes. Entangled qubits may transfer the quantum states of the qubits. The qubits may be in proximity or work over a distance.

The second quantum computer may monitor for a party that obtains unauthorized access to the encrypted data on the first set of qubits on the first quantum computer.

The second quantum computer may detect a party obtaining unauthorized access to the encrypted data on the first set of qubits on the first quantum computer.

The quantum computer may check for signs of unauthorized use, for example, by checking logs. Logs may include user login, file access, network traffic, and system errors. Monitoring logs may also include monitoring Wi-Fi and Bluetooth connections, call and text logs, and data usage. The quantum computer may check for unauthorized use by reviewing network monitoring tools to look for abnormal and/or suspicious activity. The quantum computer may implement and monitor intrusion detection and prevention systems (“IDS/IPS”). IDS/IPS may be software or hardware solutions for monitoring network traffic to look for signs of malicious or unauthorized activity. The quantum computers may verify if correct login attempts were made and if multi-factor authentication was utilized.

The second quantum computer may cleanse in real-time the encrypted data of the first set of qubits on the first quantum computer.

Real-time cleansing using the second quantum computer may cause the encrypted data to be removed from the memory of the first set of qubits on the first quantum computer before the second quantum computer is subject to unauthorized access.

The quantum computer may cleanse the contents of the first set of qubits, for example, by allowing the qubits to lose coherence with other qubits. The other qubits may include the second set of qubits. The loss of coherence may include a loss of the quantum states of the first set of qubits. The loss of coherence may include a loss of entanglement with other qubits. The other qubits may include the second set of qubits.

The quantum computer may apply QEC to modulate quantum states of either of the sets of the first set of qubits. The QEC may maintain the quantum states by maintaining the coherence of the sets of qubits with each other. The QEC may allow the quantum states of either set of qubits to be lost through decoherence, for example, when there has been unauthorized access to the first device. Cleansing the first set of qubits may include, for example, modulating the quantum states of the qubits to lose coherence between the first set of qubits and the second set of qubits. Loss of coherence, which may include decoherence, may result in loss of quantum states of the first set of qubits.

Decoherence of the first set of qubits may lead to cleansing the memory of the first device. Maintaining a quantum state may be fragile as it may be difficult to stop a qubit from interacting with its environment. Factors such as electromagnetic fluctuations, temperature changes, and quantum measurements may disrupt the quantum state. Noise in the system may lead to decoherence. Decoherence may include breakdown of a superposition that causes a loss of data such as a loss of the set qubits. Quantum decoherence may be a loss of quantum coherence. The quantum computer may modulate the aforementioned factors to bring about decoherence which may bring about a cleansing of memory of the first set of qubits.

Decoherence may include interactions a qubit has with its environment which causes disturbances and collapse superposition. Decoherence may lead to errors in quantum information. However, there may need to be a loose interaction of a qubit with its environment to read data held by the qubit.

Quantum systems may be fragile. Their ability to store information and operate in a way that may be exponentially greater than traditional binary computers may be related to their ability to establish and maintain coherence. Coherence may refer to synchronization and correlated behavior of the quantum system. The phenomenon of decoherence may jeopardize quantum computers from distinguishing their performance from binary computers. Decoherence may be a process in which the information stored in qubits quickly loses its quantum properties because of the interactions of the qubits with the surrounding environment.

Quantum decoherence may include the loss of quantum coherence. Understanding how quantum systems perform upon quantum decoherence may provide insight to understand how quantum systems convert to binary systems such as a binary system that may be explained by classical mechanics. Quantum computing may rely on quantum coherence. Coherence may enable quantum entanglement. Quantum computing may utilize quantum entanglement. Quantum computing may be a primary practical applications of the coherence.

The second quantum computer may restore encrypted data to the first set of qubits on the first quantum computer by transporting, using quantum entanglement, encrypted data stored on the second set of qubits on the second quantum computer to the first set of qubits on the first quantum computer.

Quantum computers may communicate using photons to transport qubits between the second device and the first device. The two devices may be close to each other. The two devices may be distant from each other. An advantage of photons may include that they are well isolated from perturbations. Isolation from perturbations may translate into long-lived superposition states for qubits that are photons. Another advantage of photons is that they may propagate along an optical fiber with low attenuation.

A quantum network may have end nodes on which applications are run. End nodes may include quantum computers that may include quantum processors containing one or more qubits. Quantum computers in the quantum network may communicate over communication lines. These may include fibers optics that may carry. The first device may be a first node. The second device may be a second node.

To transport qubits from one node to another, the quantum network may use communication lines. Communication lines may include telecom fibers such as fiber optics cables. Electromagnetic waves may also be used to transport qubits. Quantum computers may establish quantum entanglement allowing data to be teleported between the quantum computers in the quantum network.

Optical switches may be capable of delivering qubits to the intended quantum processor. The optical switches may be needed to preserve quantum coherence. Quantum coherence may be used to establish quantum entanglement. Quantum entanglement may be used to transport data from the second set of qubits on the second device to the first set of qubits on the first device.

Quantum repeaters may be utilized to transport qubits over long distances. Repeaters may appear between end nodes. Quantum entanglement may establish coherence between qubits at the end nodes. Entangled qubits may transfer the quantum states of the qubits. The qubits may be in proximity or work over a distance.

The encrypted data on the first set of qubits may be cleansed by disrupting coherence between the first set of qubits and the second set of qubits causing the first set of qubits to lose their quantum state.

The first quantum computer may be directly connected to a quantum internet.

The second quantum computer may only have a connection to a quantum internet through electronic connection to the first quantum computer.

The first quantum computer may apply QEC to maintain quantum states of the first set of qubits and the second set of qubits. Applying QEC may establish coherence between the first set of qubits and the second set of qubits.

The encrypted data on the first set of qubits may be cleansed by applying QEC to disrupt coherence between the first set of qubits and the second set of qubits causing the first set of qubits to lose their quantum state.

The first quantum computer may tag quantum states of the first set of qubits with a first tag and the second set of qubits with a second tag. The first tag may be used to identify the first location of the first set of qubits. The second tag may be used to identify a second location of the second set of qubits.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

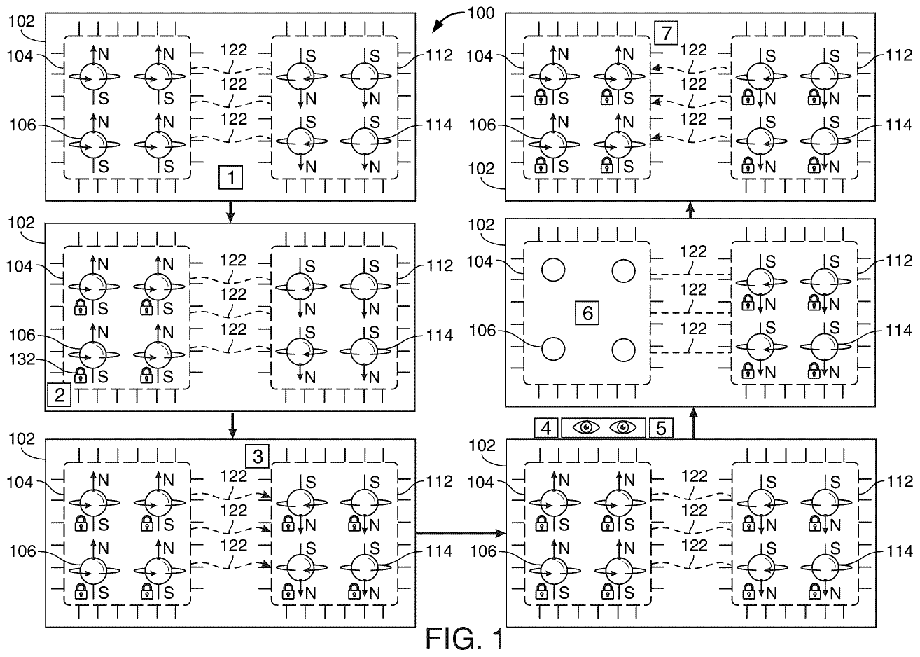

FIG. 1 shows illustrative block diagram 100. Illustrative block diagram 100 may show an apparatus that includes a system for reducing risk associated with an unauthorized party accessing a device, where risk reduction is achieved in real-time using a quantum digital twin.

The system may include quantum network 102. Quantum network 102 may include first quantum computer 104 and second quantum computer 112. First quantum computer 104 may include first set of qubits 106 at a first location. Second quantum computer 112 may include second set of qubits 114 at a second location. First set of qubits 106 and second set of qubits 114 may be entangled with quantum entanglement 122.

At step 1, quantum computing may be configured to establish a quantum digital twin between first quantum computer 104 and second quantum computer 112. The quantum digital twin may be established by entangling first set of qubits 106 with second set of qubits 114 to make quantum entanglement 122.

At step 2, quantum computing may encrypt data stored on first quantum computer 104. Encrypted data 132 may be stored on first set of qubits 106.

At step 3, quantum computing may transport through quantum entanglement 122 the encrypted data stored on first set of qubits 106 on first quantum computer 104 to second set of qubits 114 on second quantum computer 112. The encrypted data may be transported across quantum network 102.

At step 4, quantum computing may monitor for unauthorized access to the encrypted data on first set of qubits 106 on first quantum computer 104.

At step 5, quantum computing may detect unauthorized access to the encrypted data on first set of qubits 106 on first quantum computer 104.

At step 6, quantum computing may cleanse in real-time the encrypted data on first set of qubits 106 on first quantum computer 104. The quantum computing may cleanse the contents of first set of qubits 106 by bringing about decoherence in quantum entanglement 122.

At step 7, quantum computing may restore encrypted data to first set of qubits 106 on first quantum computer 104 by transporting, using quantum encryption 122, the encrypted data stored on second set of qubits 114 on second quantum computer 112 to first set of qubits 106 on first quantum computer 104.

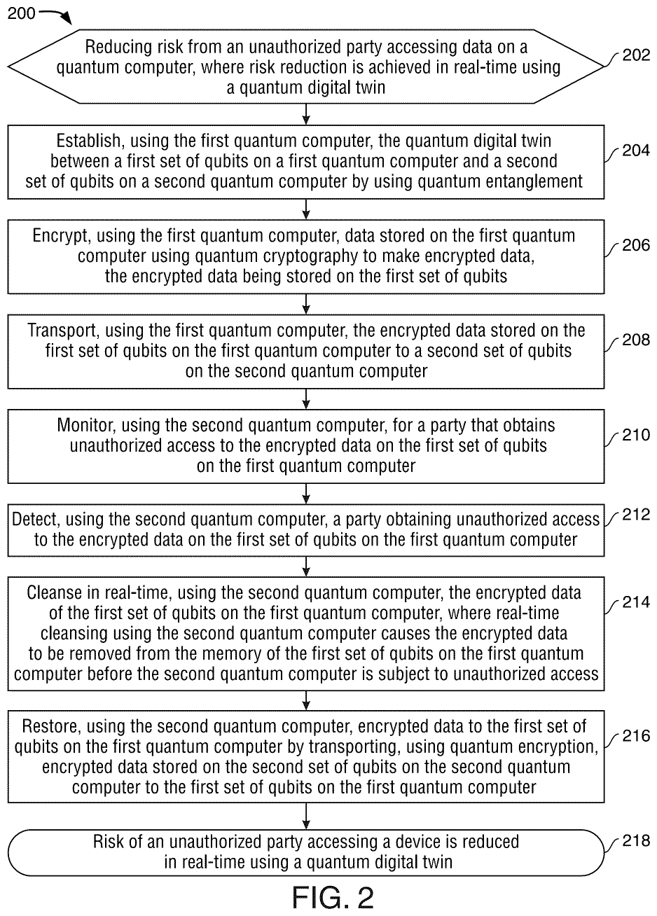

FIG. 2 shows illustrative flowchart 200, beginning at step 202, that may provide a process for reducing risk from an unauthorized party accessing data on a quantum computer, where risk reduction is achieved in real-time using a quantum digital twin.

At step 204, the first quantum computer may establish the quantum digital twin between a first set of qubit on a first quantum computer and a second set of qubits on a second quantum computer by using quantum entanglement.

At step 206, the first quantum computer may encrypt data stored on the first quantum computer using quantum cryptography to make encrypted data, the encrypted data being stored on the first set of qubits.

At step 208, the first quantum computer may transport the encrypted data stored on the first set of qubits on the first quantum computer to a second set of qubits on the second quantum computer.

At step 210, the first quantum computer may monitor for a party that obtains unauthorized access to the encrypted data on the first set of qubits on the first quantum computer.

At step 212, the first quantum computer may detect a party obtaining unauthorized access to the encrypted data on the first set of qubits on the first quantum computer.

At step 214, the second quantum computer may cleanse, in real-time, the encrypted data of the first set of qubits on the first quantum computer. Real-time cleansing using the second quantum computer may cause the encrypted data to be removed from the memory of the first set of qubits on the first quantum computer before the second quantum computer is subject to unauthorized access. The real-time cleansing may prevent an unauthorized party from gaining access to the second quantum computer.

At step 216, the second quantum computer may restore encrypted data to the first set of qubits on the first quantum computer by transporting, using quantum encryption, encrypted data stored on the second set of qubits on the second quantum computer to the first set of qubits on the first quantum computer.

At step 218, the process may be completed. The risk of an unauthorized party accessing a device may be reduced in real-time using a quantum digital twin.

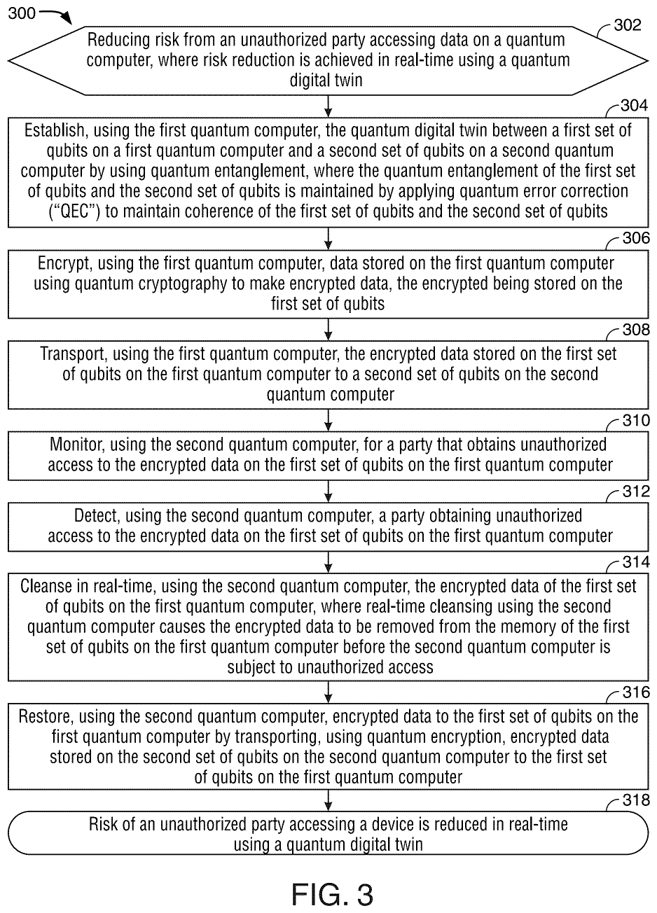

FIG. 3 shows illustrative flowchart 300, beginning at step 302, that may provide a process for reducing risk from an unauthorized party accessing data on a quantum computer, where risk reduction is achieved in real-time using a quantum digital twin.

At step 304, the first quantum computer may establish the quantum digital twin between a first set of qubit on a first quantum computer and a second set of qubits on a second quantum computer by using quantum entanglement. The quantum entanglement of the first set of qubits and the second set of qubits may be maintained by applying QEC to maintain coherence of the first set of qubits and the second set of qubits.

At step 306, the first quantum computer may encrypt data stored on the first quantum computer using quantum cryptography to make encrypted data, the encrypted data being stored on the first set of qubits.

At step 308, the first quantum computer may transport the encrypted data stored on the first set of qubits on the first quantum computer to a second set of qubits on the second quantum computer.

At step 310, the first quantum computer may monitor for a party that obtains unauthorized access to the encrypted data on the first set of qubits on the first quantum computer.

At step 312, the first quantum computer may detect a party obtaining unauthorized access to the encrypted data on the first set of qubits on the first quantum computer.

At step 314, the second quantum computer may cleanse, in real-time, the encrypted data of the first set of qubits on the first quantum computer. Real-time cleansing using the second quantum computer may cause the encrypted data to be removed from the memory of the first set of qubits on the first quantum computer before the second quantum computer is subject to unauthorized access.

At step 316, the second quantum computer may restore encrypted data to the first set of qubits on the first quantum computer by transporting, using quantum encryption, encrypted data stored on the second set of qubits on the second quantum computer to the first set of qubits on the first quantum computer.

At step 318, the process may be completed. The risk of an unauthorized party accessing a device may be reduced in real-time using a quantum digital twin.

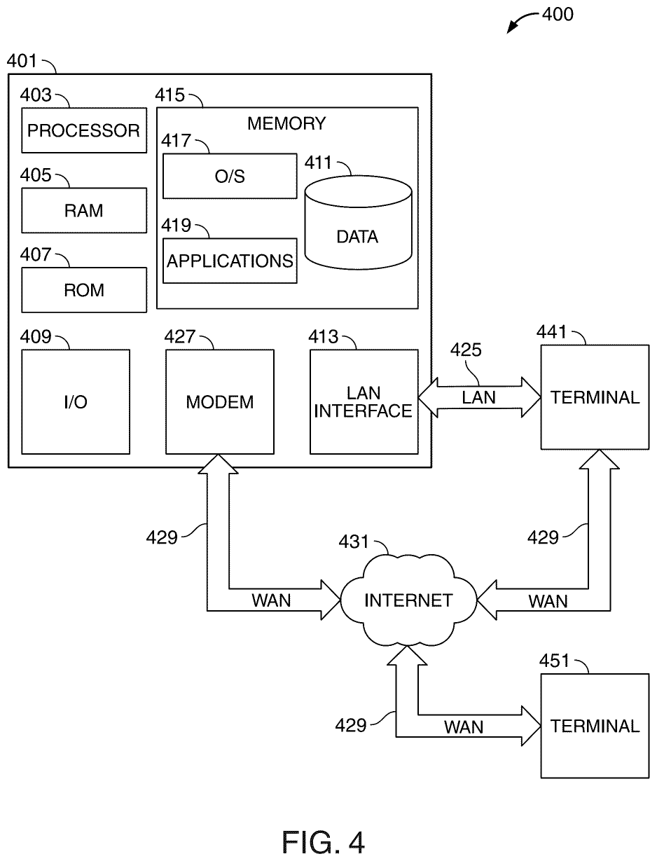

In accordance with principles of the disclosure, FIG. 4 shows an illustrative block diagram of apparatus 400 that includes a computer or computer system 401. Apparatus 400 may include one or more features of the apparatus shown in FIGS. 1-5. Computer 401 may alternatively be referred to herein as a “computing device” or “computing system”. Computer 401 may be a quantum computer or part of a quantum computer. Elements of apparatus 400, including computer 401, may be used to implement various aspects of the apparatus and methods disclosed herein. A “user” of apparatus 400 or computer 401 may include other computer systems or servers or computing devices, such as the program described herein.

Computer 401 may have one or more “N” qubit processors as well as standard microprocessors 403 for controlling the operation of the device and its associated components, and may include RAM 405, ROM 407, input/output module 409, and a memory 415. The processors 403 may also execute all software running on the computer 401—e.g., the operating system 417 and applications 419. The processors 403 may establish quantum entanglement between qubits such as qubits in various locations. The processors 403 may run QEC. QEC may maintain coherence between entangled qubits. The processors 403 may establish correlation between qubits in various locations. Other components commonly used for computers, such as EEPROM or Flash memory or any other suitable components, may also be part of the computer 401.

The memory 415 may be comprised of any suitable permanent storage technology—e.g., a hard drive or other non-transitory memory. The ROM 407 and RAM 405 may be included as all or part of memory 415. The memory 415 may store software including the operating system 417 and application(s) 419 along with any other data 411 (e.g., historical data, configuration files) needed for the operation of the apparatus 400. Memory 415 may also store applications and data. Alternatively, some or all of computer executable instructions (alternatively referred to as “code”) may be embodied in hardware or firmware (not shown). The microprocessor 403 may execute the instructions embodied by the software and code to perform various functions.

Memory 415 may store data as quantum states. Data may be transferred between qubits through quantum entanglement. Data may be stored on qubits as quantum states that are correlated to quantum states on other qubits. Data may be transferred between qubits through quantum entanglement.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) along with any data needed for the operation of the apparatus. The data may also be stored in cache memory, or any other suitable memory.

An input/output (“I/O”) module 409 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 401, the processor or processors 403 may execute the instructions in all or some of the operating system 417, any applications 419 in the memory 415, any other code necessary to perform the functions in this disclosure, and any other code embodied in hardware or firmware (not shown).

In an embodiment, apparatus 400 may consist of multiple computers 401, along with other devices. A computer 401 may be a mobile computing device such as a smartphone or tablet.

Apparatus 400 may be connected to other systems, computers, servers, devices, and/or the Internet 431 via a local area network (LAN) interface 413.

Apparatus 400 may operate in a networked environment supporting connections to one or more remote computers and servers, such as terminals 441 and 451, including, in general, the Internet and “cloud”. These remote computers and servers, terminals 441 and 451 (as well as other terminals, not shown) may be other quantum computers. Quantum computers may interact with each other over a quantum network. Quantum computers may interact with each other through quantum entanglement. References to the “cloud” in this disclosure generally refer to the Internet, which is a world-wide network. “Cloud-based applications” generally refer to applications located on a server remote from a user, wherein some or all the application data, logic, and instructions are located on the internet and are not located on a user's local device. Cloud-based applications may be accessed via any type of internet connection (e.g., cellular or Wi-Fi).

Terminals 441 and 451 may be other quantum computers or servers that include many or all the elements described above relative to apparatus 400. The network connections depicted in FIG. 4 include a local area network (LAN) 425 and a wide area network (WAN) 429 but may also include other networks. Computer 401 may include a network interface controller (not shown), which may include a modem 427 and LAN interface or adapter 413, as well as other components and adapters (not shown). When used in a LAN networking environment, computer 401 is connected to LAN 425 through a LAN interface or adapter 413. When used in a WAN networking environment, computer 401 may include a modem 427 or other means for establishing communications over WAN 429, such as Internet 431. The modem 427 and/or LAN interface 413 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system may be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 419 (which may be alternatively referred to herein as “plugins,” “applications,” or “apps”) may include computer executable instructions for a quantum authentication program and security protocols, as well as other programs. In an embodiment, one or more programs, or aspects of a program, may use one or more quantum authentication and AI/ML algorithm(s). The various tasks may be related to authenticating a user with a quantum computer.

Computer 401 may also include various other components, such as a battery (not shown), speaker (not shown), a network interface controller (not shown), and/or antennas (not shown).

Any information described above in connection with data 411, and any other suitable information, may be stored in memory 415. One or more of applications 419 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, multiprocessor systems, microprocessor-based systems, set top boxes, programmable consumer electronics, network PCs, minicomputers, mainframe computers, distributed computing environments that include any of the above systems or devices, quantum computers and the like.

Aspects of the invention may be described in the general context of computer-executable instructions, such as program modules, being executed by a computer. Generally, program modules include routines, programs, objects, components, data structures, etc., that perform tasks or implement abstract data types. The invention may also be practiced in distributed computing environments where tasks are performed by remote processing devices that are linked through a communications network, e.g., cloud-based applications. In a distributed computing environment, program modules may be in both local and remote computer storage media including memory storage devices.

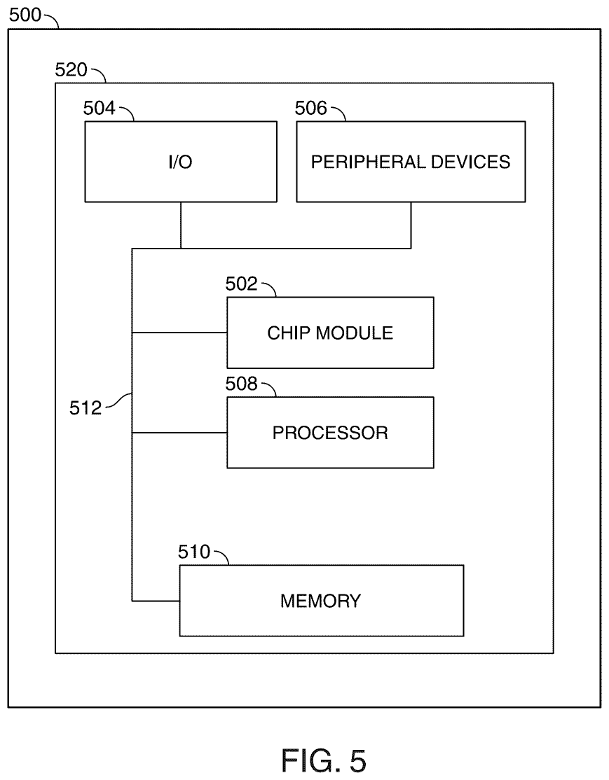

FIG. 5 shows illustrative apparatus 500 that may be configured in accordance with the principles of the disclosure. Apparatus 500 may be a quantum computer, a server, or computer with various peripheral devices 506. Apparatus 500 may include one or more features of the apparatus shown in FIGS. 1-5. Apparatus 500 may include chip module 502, which may include one or more quantum and integrated circuits, and which may include logic configured to perform any other suitable logical operations.

Apparatus 500 may include one or more of the following components: I/O circuitry 504, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 506, which may include other computers, logical processing device 508, which may be quantum based and may compute data information and structural parameters of various applications, and machine-readable memory 510.

Machine-readable memory 510 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 502, 504, 506, 508 and 510 may be coupled together by a system bus or other interconnections 512 and may be present on one or more circuit boards such as 520. In some embodiments, the components may be integrated into a single chip. The chip may be silicon-based. The chip may be quantum-based.

Thus, provided may be systems and methods relating to reducing risk from an unauthorized party accessing a device, where risk reduction is achieved in real-time using a quantum digital twin. Persons skilled in the art will appreciate that the present invention may be practiced by other than the described embodiments, which are presented for purposes of illustration rather than of limitation. The present invention is limited only by the claims that follow.

What is claimed is:

1. A method for reducing risk from an unauthorized party accessing a quantum computer, where risk reduction is achieved in real-time using a quantum digital twin, the method comprising:
establishing, using a first quantum computer, the quantum digital twin between a first set of qubits on a first quantum computer and a second set of qubits on a second quantum computer by using quantum entanglement;
encrypting, using the first quantum computer, data stored on the first quantum computer using quantum cryptography to make encrypted data, said encrypted data is stored on the first set of qubits;
transporting through quantum entanglement, using the first quantum computer, the encrypted data stored on the first set of qubits on the first quantum computer to a second set of qubits on the second quantum computer;
monitoring, using the second quantum computer, for a party that obtains unauthorized access to the encrypted data on the first set of qubits on the first quantum computer;
detecting, using the second quantum computer, a party obtaining unauthorized access to the encrypted data on the first set of qubits on the first quantum computer;
cleansing in real-time, using the second quantum computer, the encrypted data of the first set of qubits on the first quantum computer; and
restoring, using the second quantum computer, encrypted data to the first set of qubits on the first quantum computer by transporting, using quantum entanglement, encrypted data stored on the second set of qubits on the second quantum computer to the first set of qubits on the first quantum computer;
wherein real-time cleansing using the second quantum computer causes the encrypted data to be removed from memory of the first set of qubits on the first quantum computer before the second quantum computer is subject to unauthorized access.

2. The method of claim 1 wherein the encrypted data on the first set of qubits are cleansed by disrupting coherence between the first set of qubits and the second set of qubits causing the first set of qubits to lose their quantum state.

3. The method of claim 1 wherein the first quantum computer is directly connected to a quantum internet.

4. The method of claim 1 wherein the second quantum computer only has a connection to a quantum internet through electronic connection to the first quantum computer.

5. The method of claim 1 further comprising, using the first quantum computer, applying quantum error correction (“QEC”) to maintain quantum states of the first set of qubits and the second set of qubits.

6. The method of claim 5 wherein applying QEC establishes coherence between the first set of qubits and the second set of qubits.

7. The method of claim 5 wherein the encrypted data on the first set of qubits are cleansed by applying QEC to disrupt coherence between the first set of qubits and the second set of qubits causing the first set of qubits to lose their quantum state.

8. The method of claim 1 further comprising:
tagging, using the first quantum computer, quantum states of the first set of qubits with a first tag and the second set of qubits with a second tag;
wherein:
the first tag is used to identify a first location of the first set of qubits; and
the second tag is used to identify a second location of the second set of qubits.

9. A system for reduction of risk from an unauthorized party accessing a quantum computer, where reduction of risk is achieved in real-time using a quantum digital twin, the system comprising:
a first quantum computer;
a first set of qubits;
a second quantum computer;
a second set of qubits;
the first quantum computer, the second quantum computer, or the first quantum computer and the second quantum computer are configured to:
establish the quantum digital twin between the first set of qubits on the first quantum computer and the second set of qubits on the second quantum computer by using quantum entanglement;
encrypt data stored on the first quantum computer using quantum cryptography to make encrypted data, said encrypted data is stored on the first set of qubits;
transport through quantum entanglement the encrypted data stored on the first set of qubits on the first quantum computer to a second set of qubits on the second quantum computer;
monitor for a party that obtains unauthorized access to the encrypted data on the first set of qubits on the first quantum computer;
detect a party obtaining unauthorized access to the encrypted data on the first set of qubits on the first quantum computer;
cleanse in real-time the encrypted data of the first set of qubits on the first quantum computer; and
restore encrypted data to the first set of qubits on the first quantum computer by transporting, using quantum entanglement, encrypted data stored on the second set of qubits on the second quantum computer to the first set of qubits on the first quantum computer;
wherein real-time cleansing using the second quantum computer causes the encrypted data to be removed from memory of the first set of qubits on the first quantum computer before the second quantum computer is subject to unauthorized access.

10. The system of claim 9 wherein the encrypted data on the first set of qubits are cleansed by disrupting coherence between the first set of qubits and the second set of qubits causing the first set of qubits to lose their quantum state.

11. The system of claim 9 wherein the first quantum computer is directly connected to a quantum internet.

12. The system of claim 9 wherein the second quantum computer only has a connection to a quantum internet through electronic connection to the first quantum computer.

13. The system of claim 9 further comprising, using the first quantum computer, apply quantum error correction (“QEC”) to maintain quantum states of the first set of qubits and the second set of qubits.

14. The system of claim 9 wherein applying QEC establishes coherence between the first set of qubits and the second set of qubits.

15. The system of claim 9 wherein the encrypted data on the first set of qubits are cleansed by applying QEC to disrupt coherence between the first set of qubits and the second set of qubits causing the first set of qubits to lose their quantum state.

16. The system of claim 9 further comprising:
tagging, using the first quantum computer, quantum states of the first set of qubits with a first tag and the second set of qubits with a second tag;
wherein:
the first tag is used to identify a first location of the first set of qubits; and
the second tag is used to identify a second location of the second set of qubits.

17. A method for reducing risk from an unauthorized party accessing a quantum computer, where reducing risk is achieved in real-time using a quantum digital twin, the method comprising:
establishing, using a first quantum computer, the quantum digital twin between a first set of qubits on a first quantum computer and a second set of qubits on a second quantum computer by using quantum entanglement, where the quantum entanglement of the first set of qubits and the second set of qubits is maintained by applying quantum error correction (“QEC”) to maintain coherence of the first set of qubits and the second set of qubits;
encrypting, using the first quantum computer, data stored on the first quantum computer using quantum cryptography to make encrypted data, said encrypted data is stored on the first set of qubits;
transporting through quantum entanglement, using the first quantum computer, the encrypted data stored on the first set of qubits on the first quantum computer to a second set of qubits on the second quantum computer;
monitoring, using the second quantum computer, for a party that obtains unauthorized access to the encrypted data on the first set of qubits on the first quantum computer;
detecting, using the second quantum computer, a party obtaining unauthorized access to the encrypted data on the first set of qubits on the first quantum computer;
cleansing in real-time, using the second quantum computer, the encrypted data of the first set of qubits on the first quantum computer; and
restoring, using the second quantum computer, encrypted data to the first set of qubits on the first quantum computer by transporting, using quantum entanglement, encrypted data stored on the second set of qubits on the second quantum computer to the first set of qubits on the first quantum computer;
wherein real-time cleansing using the second quantum computer causes the encrypted data to be removed from memory of the first set of qubits on the first quantum computer before the second quantum computer is subject to unauthorized access.

18. The method of claim 17 wherein the encrypted data on the first set of qubits is cleansed by applying QEC to disrupt coherence between the first set of qubits and the second set of qubits causing the first set of qubits to lose their quantum state.

19. The method of claim 17 further comprising:
tagging, using the first quantum computer, quantum states of the first set of qubits with a first tag and the second set of qubits with a second tag;
wherein:
the first tag is used to identify a first location of the first set of qubits; and
the second tag is used to identify a second location of the second set of qubits.
